(19) United States
(12) Patent Application Publication
(10) Pub. No.: US 2022/0043382 A1
(43) Pub. Date: Feb. 10, 2022

(54) ASSISTED EJECTION OF PRINT JOBS

(71) Applicant: Hewlett-Packard Development Company, L.P., Spring, TX (US)

(72) Inventors: Jody L. Clayburn, Vancouver, WA (US); Stephen Thomas Rohman, Vancouver, WA (US); Matthew Raisanen, Vancouver, WA (US); Bartley S. Helms, Vancouver, WA (US)

(73) Assignee: Hewlett-Packard Development Company, L.P., Spring, TX (US)

(21) Appl. No.: 17/278,699

(22) PCT Filed: Dec. 4, 2018
(86) PCT No.: PCT/US2018/063789

§ 371 Date: Mar. 23, 2021

(51) Int. Cl. G03G 15/00; G03G 21/20

(52) U.S. Cl. CPC G03G 15/5041; G03G 15/5025; G03G 15/6529; G03G 21/203

(57) ABSTRACT

A method of controlling the ejection speed of a print job that includes, with a density module of a printing device, determining a density classifier based on a region of a plane where print fluid is to be printed for a plurality of sheets of media of a print job; determining a percentage of each sheet of media exceeding a threshold density classifier relative to a total sheet count of the print job; and, based on the percentage, initiating an assisted ejection of the print job from the printing device.

### BACKGROUND

Printing devices may improve the speed and quality of print jobs. By increasing the speed of printing the print job, time may be saved waiting at the printing device and more time may be spent conducting relatively more productive tasks. When the speed of the fulfillment of the print job is matched with an increase in quality of the print job, work productivity may be further increased.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flowchart showing a method of controlling the ejection speed of a print job according to an example of the principles described herein.

FIG. 2 is a block diagram of a printing device according to an example of the principles described herein.

FIG. 3 is a flowchart depicting a method of assisting an ejection of a print job according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

During printing operations, many different types of operations may occur to any given sheet of media being passed through the printing device. These operations include an image application process (herein as a printing process), stapling process, collation process, and hole punching process, among others. After the printing process, however, certain characteristics of the media may be altered including the stiffness, surface friction, and other handling capabilities of the media. Indeed, based on the amount of printing fluid applied to any given media, the flexibility of the media may be altered in such a way that it may be relatively more difficult for the printing device to convey the media through the printing device and to a final receptacle such as a tray.

In order to better protect the quality of the printed media as well as prevent damage to the individual sheets of media, the printing device may include any number of additional assisting devices used to gently convey certain media through and out of the printing device. Regardless of what assisting devices may be used, the use of these additional assisting devices may prevent damage to the printed media as well as damage to the printing device. As a result, however, of the use of these additional assisting devices, the printed media may exit the printing device at a slower rate than otherwise. So as to determine when the additional assisting devices are to be used to assist the ejection of any sheet of media from the printing device, the processor of the presently described printing device may detect certain characteristics of any print job that may contain any number of sheets of print media.

The present specification describes a method of controlling the ejection speed of a print job that includes, with a density module of a printing device, determining a density classifier based on a region of a plane where print fluid is to be printed for a plurality of sheets of media of a print job; determining a percentage of each sheet of media exceeding a threshold density classifier relative to a total sheet count of the print job; and, based on the percentage, initiating an assisted ejection of the print job from the printing device.

The present specification also describes a printing device includes a density module to, when executed by a processor, determine: a density classifier based on a region of a plane where print fluid is to be printed for a plurality of sheets of media of a print job; and a percentage of each sheet of media exceeding a threshold density classifier relative to a total sheet count of the print job; and an ejection assisting module to, based on the percentage, initiate an assisted ejection of the print job from the printing device.

The present specification further describes a method of assisting the ejection of a print job that includes determining whether one of a plurality of preclusion characteristics are associated with the print job; when the preclusion characteristics are not associated with the print job, with a density module executed by a processor: determining a density classifier based on a region of a plane where print fluid is to be printed for a plurality of sheets of media of a print job; and determining a percentage of each sheet of media exceeding a threshold density classifier relative to a total sheet count of the print job; and with an ejection assisting module, initiating an assisted ejection of the print job from the printing device.

As used in the present specification and in the appended claims, the term “printing device” is meant to be understood as any device that prints content on a physical medium (e.g., paper or film, etc.) with a print fluid (e.g., ink or toner). Thus, in any example, the printing device may be used to form a two-dimensional image. A print device may utilize suitable printing consumables, such as ink, toner, fluids or powders, or other raw materials for printing. An example of print fluid is a substance ejectable from a printhead, such as ink, toner, gloss enhancer, a reflective enhancer, and fluorescing agents, among others.

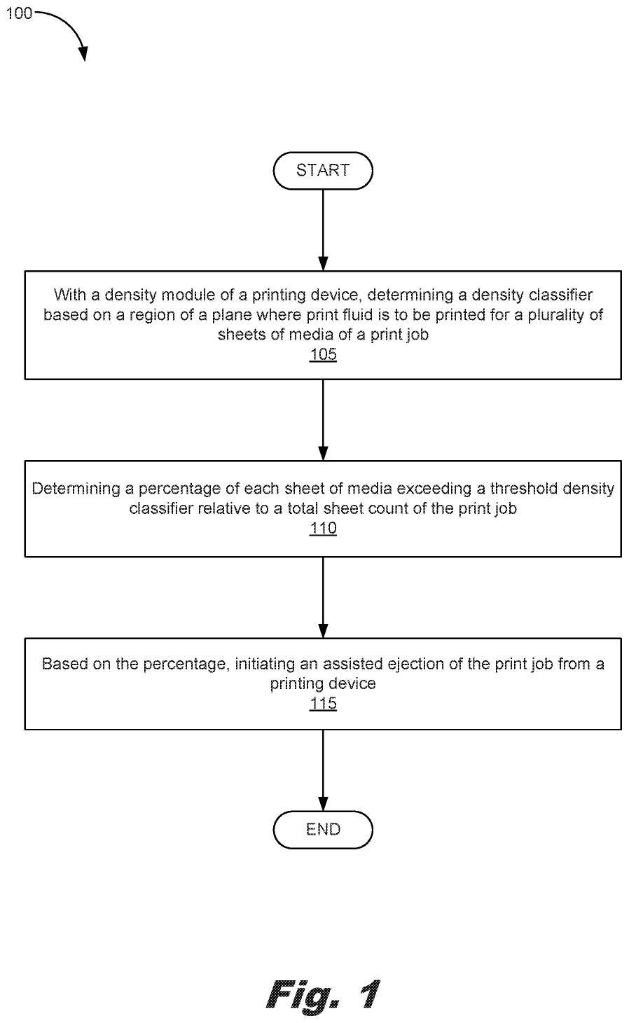

Turning now to the figures, FIG. 1 is a flowchart showing a method (100) of controlling the ejection speed of a print job according to an example of the principles described herein. The method (100) may include, with a density module of a printing device, determining (105) a density classifier based on a region of a plane where print fluid is to be printed for a plurality of sheets of media of a print job. Determining (105) the density classifier may be accomplished using any process that detects the placement and density of printing fluid at any region where the printing fluid is either to be placed on the individual sheets of media or are actually placed on the individual sheets of media. Wetting individual sheets of media with quantities of aqueous printing fluids may cause the media to swell, distort, buckle, and/or curl at different rates and degrees. Thus, media that is wet with a particular amount of printing fluid may not move along the print path in the same way as media wet with a different degree of printing fluid density (e.g., a blank page with no printing fluid versus a photograph covering the entire media). This may be especially true with specific types of media. The effect of the printing fluid on the state of the media may be influenced by the application regions of the printing fluid on a plane of the media and/or the amount of printing fluid applied in those regions of the plane. As used herein, the plane may refer to the plane on which a printing fluid is to be or is applied to the media. A density classifier, as used herein, is any value, number, character, string, label, category, or other identifier capable of representing a classification related to print fluid density applied or to be applied by the printing device on the media or build platform. For example, the density classifier may be represented as a score for print fluid density of the plane, and the density module may determine this score during operation of the printing device and during implementation of the method (100) described herein.

In a specific example, the density module, according to the method (100) described herein, may identify where printing fluid is to be printed on the plane based on data of a print job. The print fluid to be printed may be represented topographically by representing the plane with features of print fluid on any area of the plane, such as a representation of the quantity of print fluid on each region of the plane. For example, a topographical representation of the page size (and page orientation) of the print job may be generated that represents the print job data (i.e., data of the print job that represents the print content) and compared to boundaries of the page on which the print content is to be placed. For another example, print job data may be mapped to topographical regions to receive print fluid on the plane and the plane may be divided into a plurality of tiles where each tile comprises a number of pixels. In this example, density module may determine whether print fluid data representing an amount of print fluid to place at a first tile within the plane region achieves a density condition. As used herein, a tile is a quadrilateral section of the plane that includes a pixel and a density condition is a representation of a state of print fluid, such as a threshold amount of print fluid within a region, a color of print fluid at a region, a quality of the print fluid at a region, and the like. An example density condition may include multiple density conditions (e.g., multiple density thresholds or multiple layers of print density). In an example, the density module may determine the density classifier for the plane based on the relationship of the regions that are to receive a threshold amount of print fluid. The density module may assign a value to the region based on a relationship between a location of the first tile and a location of a second tile within the plane region and select the density classifier based on the value of the region. The relationship may be predetermined. For example, a lookup table of regions with particular relationships to distortions may be accessed. For another example, a matrix of weights associated with tiles of the plane may be used, where the matrix represents a weighted value of printing fluid at a particular location on the plane. In that example, the weights associated with the tiles may be used to calculate regional density scores and/or a page score that represents a density level of the page with weighting influenced by the location of the print density levels. A score, as used herein, may be generated and/or used by the density module to determine a density classifier. For example, the density module may identify the density classifier using a lookup table with the page score as input in the lookup operation. Whatever process is used to develop a density score, the density module may assign a value to the place region based on a relationship between a location of the first tile and a location of a second tile within the plane region and select the density classifier based on the value of the plane region.

After the density module has determined (105) the density classifier, the method (100) may continue with determining (110) a percentage of each sheet of media exceeding a threshold density classifier relative to a total sheet count of the print job. As descried herein, the density classifier may be in the form of a score that is compared to a threshold score. The threshold score may be set to distinguish a certain type of printed sheet of media from another. In an example, certain levels of printing fluid densities may be grouped into classes and the threshold may be a threshold class.

During operation, a process may be provided with a count of individual sheets of media that meets or exceeds the threshold. For each sheet of media that meets or exceeds the threshold, the processor may up-count a counter. When all of the sheets of media within a given print job are so analyzed, the ratio or percentage of sheets of media that meet or exceed the threshold relative to the entire number of sheets of media within the print job. By way of example, a print job may have 60 sheets of media that receive an amount of printing fluid thereon. During execution of the method (100), the density module, may determine that 30 of the 60 sheets exceed the printing fluid density to be distributed onto or is distributed on those sheets of media exceed the set threshold. Consequently, it is then determined (110) that the percentage of printing-fluid-density-threshold-exceeding sheets of media are ½ or 50% of the total number of sheets of media within the print job. Thus, based on that percentage, the printing device may initiate (115) an assisted ejection of the print job from the printing device. In an example, a threshold percentage may be set such that when this threshold percentage is met or exceeded, the printing device initiates (115) the assisted ejection process of the print job from the printing device. In an example, this threshold percentage may be between 39% and 69%. In an example, this threshold percentage may be 49%. In an example, this threshold may be 59%.

In an example, the method (100) described herein may include initially determining whether certain preclusion characteristics are associated with any given print job. In an example, the preclusion characteristics may include a size of the sheet of media; duplex printing on the sheet of media; a humidity during the print job; the type of print media; a size of the print job; or a combination thereof. The preclusion characteristics may, when determined to exist, may preclude the initiation of the method (100) described herein and instead may indicate to a processor of the printing device that an assisted ejection process should be initiated (115) regardless of the determined (105) density classifier for any given sheet. However, where some or none of the preclusion characteristics is not found to be descriptive of or associated with any given print job, the method (100) may be used to more accurately determine whether the assisted ejection should be initiated (115) as described herein.

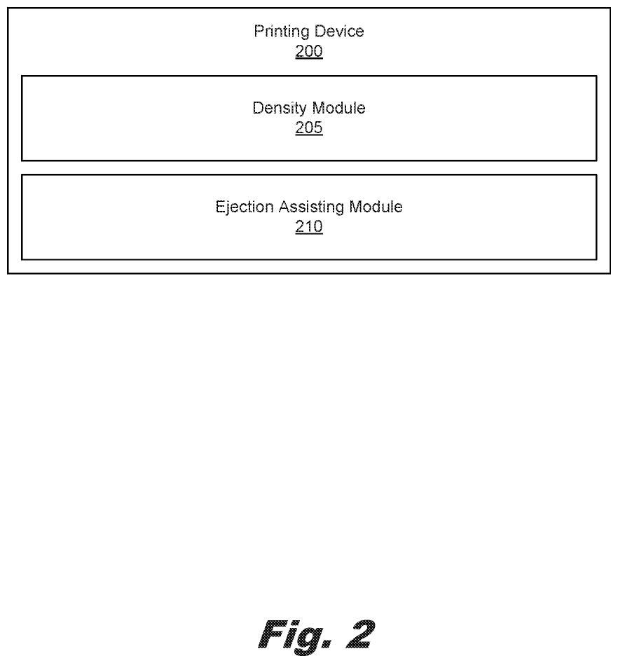

FIG. 2 is a block diagram of a printing device (200) according to an example of the principles described herein. The printing device (200) may include a density module (205) and an ejection assisting module (210). Each of the density module (205) and ejection assisting module (210) may be communicatively coupled to a processing device that may receive and send signals to and from the density module (205), ejection assisting module (210), and other devices within the printing device (200).

The printing device (200) may be utilized in any data processing scenario including, stand-alone hardware, mobile applications, through a computing network, or combinations thereof. Further, the printing device (200) may be used in a computing network, a public cloud network, a private cloud network, a hybrid cloud network, other forms of networks, or combinations thereof. In one example, the methods provided by the printing device (200) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules (205, 210) in the system can be executed on one or across multiple platforms. Such modules can run on various forms of cloud technologies and hybrid cloud technologies or offered as a SaaS (Software as a service) that can be implemented on or off the cloud. In another example, the methods provided by the printing device (200) are executed by a local administrator.

To achieve its desired functionality, the printing device (200) comprises various hardware components. Among these hardware components may be a number of processors, a number of data storage devices, a number of peripheral device adapters, and a number of network adapters. These hardware components may be interconnected through the use of a number of busses and/or network connections. In one example, the processor, data storage device, peripheral device adapters, and a network adapter may be communicatively coupled via a bus.

The processor may include the hardware architecture to retrieve executable code from the data storage device and execute the executable code. The executable code may, when executed by the processor, cause the processor to implement the functionality of determining a density classifier based on a region of a plane where print fluid is to be printed for a plurality of sheets of media of a print job; determining a percentage of each sheet of media exceeding a threshold density classifier relative to a total sheet count of the print job; and based on the percentage, initiating an assisted ejection of the print job from the printing device, among other functionalities according to the methods of the present specification described herein. In the course of executing code, the processor may receive input from and provide output to a number of the remaining hardware units.

The data storage device may store data such as executable program code that is executed by the processor or other processing device. The data storage device may specifically store computer code representing a number of applications that the processor executes to implement the functionality described herein. The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage purposes. For example, in certain examples the processor may boot from Read Only Memory (ROM), maintain nonvolatile storage in the Hard Disk Drive (HDD) memory, and execute program code stored in Random Access Memory (RAM). The data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the printing device (200) enable the processor to interface with various other hardware elements, external and internal to the printing device (200). For example, the peripheral device adapters may provide an interface to input/output devices, such as, for example, display device, a mouse, or a keyboard. The peripheral device adapters may also provide access to other external devices such as an external storage device, a number of network devices such as, for example, servers, switches, and routers, client devices, other types of computing devices, and combinations thereof.

The display device may be provided to allow a user of the printing device (200) to interact with and implement the functionality of the methods described herein. The peripheral device adapters may also create an interface between the processor and the display device or other media output devices. The network adapter may provide an interface to other computing devices within, for example, a network, thereby enabling the transmission of data between the printing device (200) and other devices located within the network.

The various modules (205, 210) within the printing device (200) comprise executable program code that may be executed separately. In this example, the various modules (205, 210) may be stored as separate computer program products. In another example, the various modules (205, 210) within the printing device (200) may be combined within a number of computer program products; each computer program product comprising a number of the modules. In an example, the module (205, 210) may take the form of an application specific integrated circuit (ASIC). In this example, the processor of the printing device (200) may be communicatively coupled to these ASICs such that process signals may be exchanged between the processor and these modules (205, 210).

As described herein, the density module (205) may, when executed by the processor, determine a density classifier based on a region of a plane where print fluid is to be printed for a plurality of sheets of media of a print job. As described herein, the density classifier may include a classification of all or a portion of any sheet of media in any print job based on the amount of printing fluid deposited on the sheets of media. As described herein, the density classification may be determined based on print data descriptive of where the printing fluid is to be deposited on any given sheet of media. In an example, the density classification may be determined based on the printing fluid that has been deposited on any given sheet of media. In either example, the density classification may be assigned a score.

After the density classification has been determined, the density module (205), upon execution of the processor, may determine a percentage of each sheet of media exceeding a threshold density classifier relative to a total sheet count of the print job. Again, the number of sheets that meet the threshold density classifier relative to the total number of sheets of media in any given print job may be used to determine a percentage. The percentage may also be compared to a threshold percentage.

The ejection assisting module (210) may then, based on the percentage (i.e., whether the percentage has reached or surpassed the percentage threshold), initiate an assisted ejection of the print job from the printing device. The initiation of the assisted ejection of any given print job may include sending signals, via the processor, to certain assisting devices within the printing device (200) in order to relatively more carefully pass the print job through the or any remaining portion of the print path within the printing device (200). As used in the present specification and in the appended claims, the term “print path” is meant to be understood as any space through the printing device (200) in which a sheet of media or sheets of media passes to different areas of the printing device (200) to perform an imaging operation.

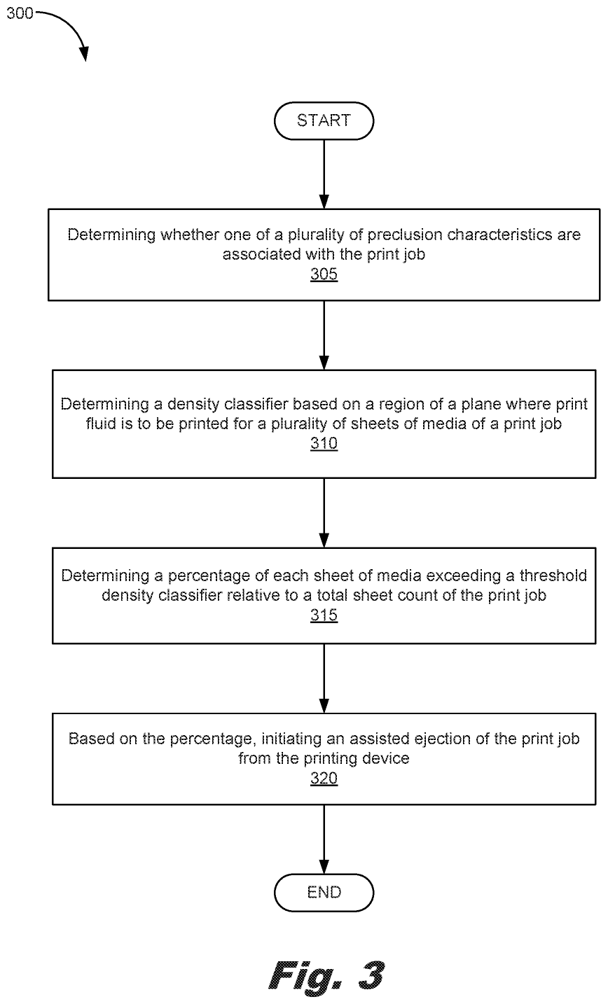

FIG. 3 is a flowchart depicting a method (300) of assisting an ejection of a print job according to an example of the principles described herein. The method (300) may include determining (305) whether one of a plurality of preclusion characteristics are associated with the print job. As described herein, these preclusion characteristics may include a size of the sheet of media; duplex printing on the sheet of media; a humidity during the print job; the type of print media; a size of the print job; or a combination thereof. These preclusion characteristics. Where any and/or all of these or similar preclusion characteristics are present, the method (300) may initiate an assisted ejection of the print job from the printing device regardless of any further calculation or determination by any of the density module (205) and/or ejection assisting module (210) as described herein.

Where the preclusion characteristics are not associate with the print job, the method (300) may continue with a density module (205) executed by a processor determining (310) a density classifier based on a region of a plane where print fluid is to be printed for a plurality of sheets of media of a print job and determining (315) a percentage of each sheet of media exceeding a threshold density classifier relative to a total sheet count of the print job. Again, the density classifier may be presented to a processor in any form such as a score related to each of the sheets of media within the given print job. This score may be used to determine which of the sheets of media in the print job meets a density threshold. A resulting percentage, for example, of density threshold exceeding sheets of media relative to the total number of sheets of media in the print job may be determined. This percentage may then be compared to a threshold percentage in order to, with an ejection assisting module (210), initiate (320) an assisted ejection of the print job from the printing device.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor of the printing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a printing device that implements a method to control the speed of the ejection of a print job or the passage of that print job through a print path in the printing device. The speed of the ejection is specifically tied to the use of a number of assisting devices within the printing device to assist the printed media through and out of the printing device. Through implementation of the method described herein, damage to the printed media may be prevented and the quality of the printed job may be increased when certain density classified pages are treated by the printing device relatively more delicately. Implementation of the method described herein also assures that, where possible, the speed of the completed print job is at a maximum while concurrently considering the delicacy of a given print job and reducing the speed of the completion of that job when it has been determined that any given print job includes a percentage of sheets of media that meet or exceed a threshold density classifier.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of controlling the ejection speed of a print job, comprising:
with a density module of a printing device, determining a density classifier based on a region of a plane where print fluid is to be printed for a plurality of sheets of media of a print job;
determining a percentage of each sheet of media exceeding a threshold density classifier relative to a total sheet count of the print job; and
based on the percentage, initiating an assisted ejection of the print job from the printing device.

2. The method of claim 1, wherein the percentage to initiate the assisted ejection is 49%.

3. The method of claim 1, wherein the density module:
determines an amount of print fluid to be placed at a first tile within the plane region achieves a density condition;
assigns a value to the plane region based on a relationship between a location of the first tile and a location of a second tile within the plane region; and
selects the density classifier based on the value of the plane region.

4. The method of claim 3, wherein the density module applies weights to the first and second tiles and wherein the weights are used to assign a value to the plane region.

5. The method of claim 1, wherein preclusion characteristics of the print job prevents the density module from initiating.

6. The method of claim 5, wherein the preclusion characteristics include:
a size of the sheet of media;
duplex printing on the sheet of media;
a humidity during the print job;
a type of print media;
a size of the print job;
or a combination thereof.

7. A printing device, comprising:
a density module to, when executed by a processor, determine:
a density classifier based on a region of a plane where print fluid is to be printed for a plurality of sheets of media of a print job; and
a percentage of each sheet of media exceeding a threshold density classifier relative to a total sheet count of the print job; and
an ejection assisting module to, based on the percentage, initiate an assisted ejection of the print job from the printing device.

8. The printing device of claim 7, wherein the density module:
determines an amount of print fluid to be placed at a first tile within the plane region achieves a density condition;
assigns a value to the plane region based on a relationship between a location of the first tile and a location of a second tile within the plane region; and
selects the density classifier based on the value of the plane region.

9. The printing device of claim 8, wherein the density module applies weights to the first and second tiles and wherein the weights are used to assign a value to the plane region.

10. The printing device of claim 7, wherein the percentage to initiate the assisted ejection is 49%.

11. The printing device of claim 7, wherein the ejection assisting module determines which of a plurality of assisting devices to actuate based on the percentage.

12. A method of assisting an ejection of a print job from a printing device, comprising:
determining whether one of a plurality of preclusion characteristics are associated with the print job;
when the preclusion characteristics are not associated with the print job, with a density module executed by a processor:
determining a density classifier based on a region of a plane where print fluid is to be printed for a plurality of sheets of media of a print job; and
determining a percentage of each sheet of media exceeding a threshold density classifier relative to a total sheet count of the print job; and
with an ejection assisting module, initiating an assisted ejection of the print job from a printing device.

13. The method of claim 12, wherein determining a density classifier comprises, for each sheet of media:
determines an amount of print fluid to be placed at a first tile within the plane region achieves a density condition;
assigns a value to the plane region based on a relationship between a location of the first tile and a location of a second tile within the plane region; and
selects the density classifier based on the value of the plane region.

14. The method of claim 13, wherein the density module applies weights to the first and second tiles and wherein the weights are used to assign a value to the plane region.

15. The method of claim 12, wherein the percentage to initiate the assisted ejection is 49%.
